(19) United States
(12) Patent Application Publication
(10) Pub. No.: US 2006/0138290 A1
(43) Pub. Date: Jun. 29, 2006

(54) Accessory support for an automobile entertainment system

(76) Inventor: Christopher J. Vitito, Celebration, FL (US)

Correspondence Address: WELSH & FLAXMAN LLC, 2000 DUKE STREET, SUITE 100, ALEXANDRIA, VA, 22314, US

(21) Appl. No.: 11/153,454

(22) Filed: Jun. 16, 2005

Related U.S. Application Data
(60) Provisional application No. 60/638,117, filed on Dec. 23, 2004.

(51) Int. Cl. B68B 5/00

(52) U.S. Cl. 248/205.2

(57) ABSTRACT

An accessory support includes a first strap member, a second strap member and a third strap member securely connected together for use in supporting accessories. The first strap member includes a first end and a second end wherein the first end is provided with a first fastening member and the second end is provided with a second fastening member, and the first and second fastening members are shaped and dimensioned for selective attachment to create a loop of the first strap member. The second strap member includes a first end and a second end wherein the first end is provided with a fastening material. The third member includes a first end and a second end wherein the first end is provided with a first fastening member and the second end is provided with a second fastening member, and the first and second fastening members are shaped and dimensioned for selective attachment to create a loop of the third strap member.

### CROSS REFERENCE TO RELATED APPLICATIONS

This application is based upon U.S. Provisional Patent No. 60/638,117, entitled “ACCESSORY SUPPORT FOR AN AUTOMOBILE ENTERTAINMENT SYSTEM”, filed Dec. 23, 2004.

### BACKGROUND OF THE INVENTION

1. Field of the Invention

The invention relates to an accessory support for an automobile entertainment system. More particularly, the invention relates to a support strap for accessories used in conjunction with an automobile entertainment system.

2. Description of the Prior Art

Entertainment systems for automobiles are well known. As such, many advances have been made in the development of entertainment systems that make the otherwise tedious task of riding in an automobile more bearable. In addition to the development of overhead systems pioneered by the present inventor, systems that mount within the headrest of an automobile have also been developed.

With the proliferation of automobile entertainment systems, has come the development of accessories used in conjunction with the automobile entertainment systems. For example, most automobile entertainment systems now come with headphones allowing children within the backseat to view a video while the parents sitting in the front seats can quietly talk or listen to the radio. In addition, many automobile entertainment systems include remote controls allowing for manipulation of the entertainment system without actually reaching to touch or otherwise physically manipulate the system.

With this in mind, and in consideration of the limited storage space available in most automobiles, where to store the accessories relating to the automobile entertainment system has become a problem. The present invention attempts to overcome this problem by providing a convenient accessory support adapted for supporting many of the accessories used within an automobile.

### SUMMARY OF THE INVENTION

It is, therefore, an object of the present invention to provide an accessory support including a first strap member, a second strap member and a third strap member securely connected together for use in supporting accessories. The first strap member includes a first end and a second end wherein the first end is provided with a first fastening member and the second end is provided with a second fastening member, and the first and second fastening members are shaped and dimensioned for selective attachment to create a loop of the first strap member. The second strap member includes a first end and a second end wherein the first end is provided with a fastening material. The third member includes a first end and a second end wherein the first end is provided with a first fastening member and the second end is provided with a second fastening member, and the first and second fastening members are shaped and dimensioned for selective attachment to create a loop of the third strap member.

It is also an object of the present invention to provide an accessory support wherein the first fastening member and the second fastening member of the first strap member are respectively hook & loop fastening material adapted for selectively engagement therewith.

It is another object of the present invention to provide an accessory support wherein the fastening material of the second strap member is hook or loop fastening material.

It is a further object of the present invention to provide an accessory support wherein the first fastening member and the second fastening member of the third strap member are respectively snap type fastening members adapted for selectively engagement therewith.

It is also an object of the present invention to provide an accessory support wherein the snap type fastening members are magnetic snaps.

It is also another object of the present invention to provide an accessory support wherein first and second strap members are integrally formed in a one-piece construction.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWING

FIG. 1 is a perspective view of the present accessory support.

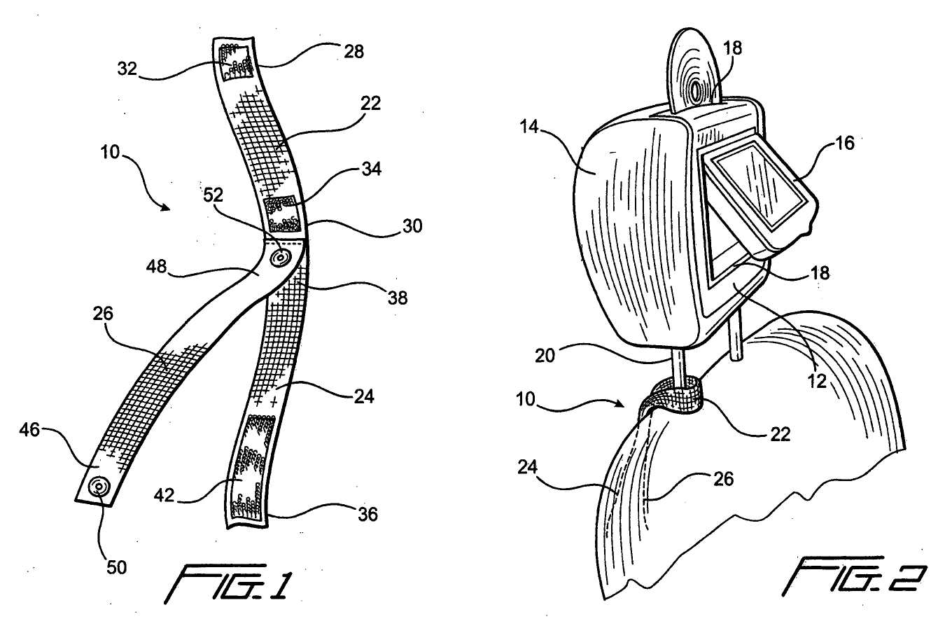

FIGS. 2 and 3 are perspective views of the accessory support shown in use within an automobile.

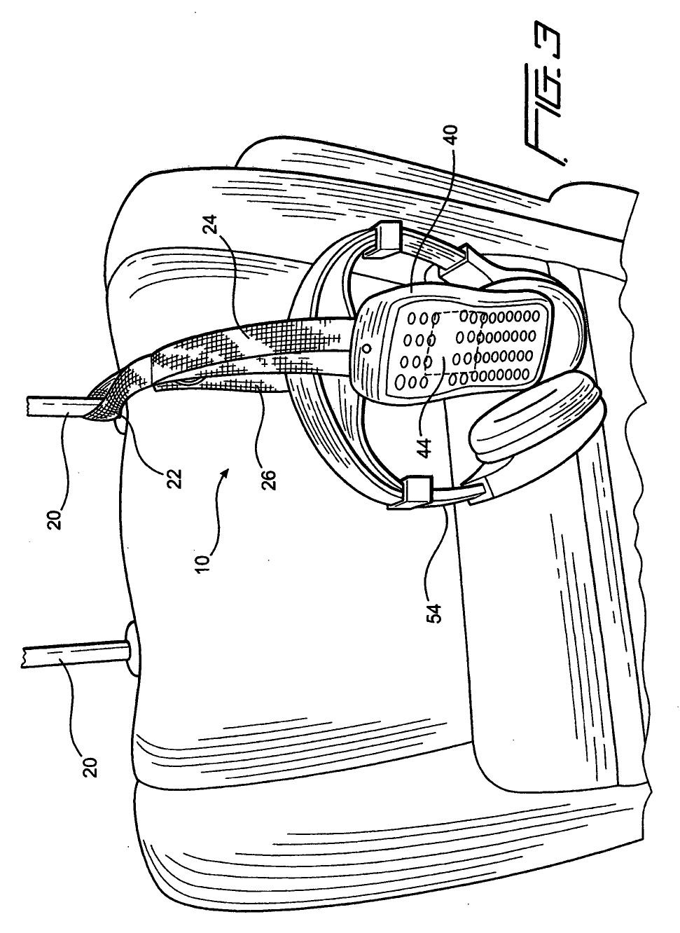

FIG. 4 is a detailed view showing attachment of the accessory support.

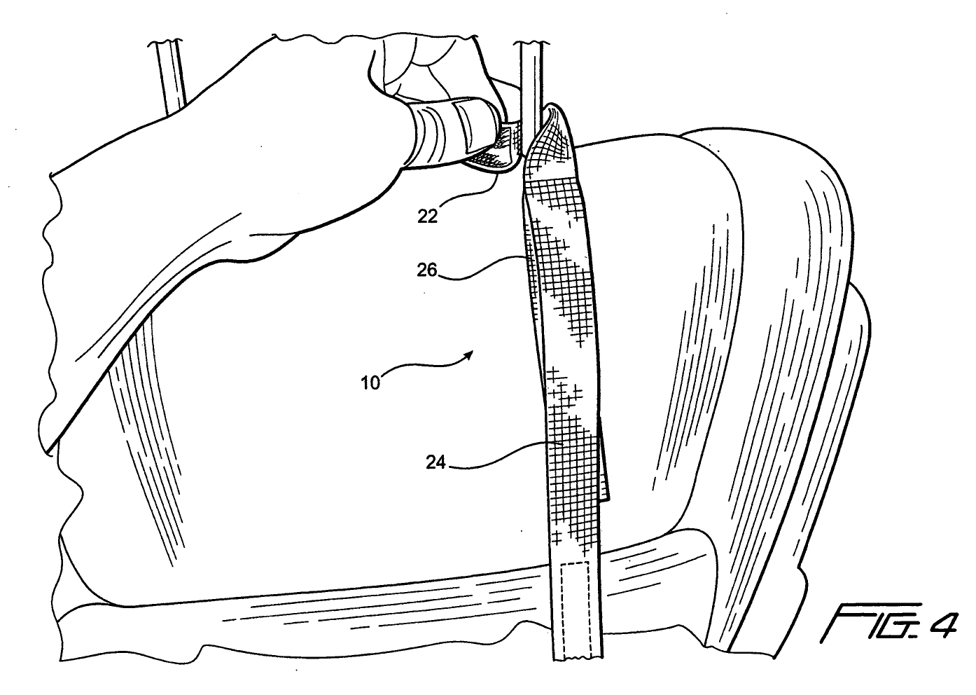

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

With reference to the various figures, an accessory support 10 for use in supporting a variety of accessories commonly used in conjunction with an automobile entertainment system 12. In accordance with preferred embodiment, the accessory support 10 is particularly adapted for use in conjunction with an automobile entertainment system 12 mounted within a standard headrest 14 of an automobile, although those skilled in the art will certainly appreciate the accessory support may be used with overhead entertainment systems and other entertainment systems without departing from the spirit of the present invention.

As such, and as those skilled in the art will certainly appreciate, a preferred automobile entertainment system 12 in accordance with the present invention is composed of a series of video and audio components integrated within an automobile headrest 14. The entertainment system 12 generally includes a video system mounted within a standard headrest 14 of an automobile. The video system generally includes a video monitor 16 for presenting video content and a video source 18 integrated therewith. The headrest 14 includes one or more support posts 20 (in accordance with a preferred embodiment two are shown) allowing the headrest 14 to be extended to a preferred height for the individuals sitting within the seat.

In accordance with a preferred embodiment of the present invention, the accessory support 10 is adapted for selective attachment to either of the headrest support posts 20 for supporting entertainment accessories behind the seat to which it is secured. Although the accessory support is disclosed for use in attachment to a headrest support post of an automobile, it is contemplated the accessory support may be used in other environments without departing from the spirit of the present invention.

In particular, the accessory support 10 includes a first strap member 22, a second strap member 24 and a third strap member 26. The first, second and third strap members 22, 24, 26 are securely connected together for use in the manner described below in greater detail. In accordance with a preferred embodiment of the present invention, the first and second strap members 22, 24 are integrally formed and the third strap member 26 is secured at the meeting point of the first strap member 22 and the second strap member 24.

As those skilled in the art will certainly appreciate, it is possible that the various strap members making up the present accessory support may be secured together using various techniques without departing from the spirit of the present invention. In addition, it is contemplated the accessory support may be constructed with additional strap members for supporting additional accessories without departing from the spirit of the present invention.

With reference to the first strap member 22, it includes a first end 28 and a second end 30. The first end 28 includes a first fastening member 32 and the second end 30 includes a second fastening member 34. The first and second fastening members 32, 34 are spaced in a manner allowing the first end 28 of the first strap member 22 to be folded over such that the first fastening member 32 selectively contacts and couples with the second fastening member 34 creating a loop of the first strap member 22. In accordance with a preferred embodiment of the present invention, the first and second fastening members 32, 34 are respective hoop & loop type fasteners, for example, VELCRO. In this way, the first strap member 22 is shaped and dimensioned for selective attachment about a support post 20 of an automobile.

The second strap member 24 is integrally formed with the first strap member 22, extending from the second end 30 of the first strap member 22. That is, the second strap member 24 includes a first end 36 and second end 38, with the second end 38 of the second strap member 24 adjacent the second end 30 of the first strap member 22 and the first end 36 of the second strap member 24 distanced from the first end 28 of the first strap member 22.

The second strap member 24 is adapted to hang freely from the first strap member 22 while the first strap member 22 is secured about a support post 20 of an automobile headrest 14. One side of the second strap member 24, preferably adjacent the first end 36 of the second strap member 24, is oriented for attachment with an entertainment system accessory, for example, a remote control 40. In particular, the one side of the second strap member 24 is provided with a fastening material 42, for example, either hook or loop material of a hook & loop fastening material, which may then be selectively secured to the mating material 44 secured to the accessory 40.

Although the fastening material is disclosed as only be secured to one side of the second strap member in accordance with a preferred embodiment of the present invention, it is contemplated fastening material may be secured to both sides of the second strap member to permit attachment of two accessories thereto. As such, and in accordance with a preferred embodiment of the present invention, the second strap member 24 includes either hook or loop fastening material 42 mounted thereon. An automobile accessory 40 with the mating fastening material 44 secured thereto may be selectively secured to the second strap member 24 to hang thereon for selective retrieval when it is needed. In addition, it is also contemplated the fastening material used above as an attachment structure for a remote control could be replaced with a pocket or other support structure while remaining within the spirit of the present invention.

The accessory support 10 further includes a third strap member 26. The third strap member 26 is secured to the first and second strap members 22, 24 at the point were the integrally formed first and second strap members 22, 24 meet. As such, the third strap member 26 includes a first end 46 and a second end 48, with the second end 48 of the third strap member 26 adjacent the respective second ends 30, 38 of the first and second strap members 22, 24 and the first end 46 of the third strap member 26 distanced from the respective first ends 28, 36 of the first and second strap members 22, 24.

The third strap member 26 includes first and second selectively releasable fastening members 50, 52 adjacent the first end 46 and the second end 48 thereof. As such, the third strap member 26 may be folded over to create a loop for the fastening of an automobile accessory, for example, a headphone 54, therein. The first and second fastening members 50, 52 of the third strap member 26 may take a variety of forms. For example, and in accordance with a preferred embodiment, magnetic snaps are provided on the first and second ends 46, 48 of the third strap member 26. This allows for the selective creation of a loop through which a headphone 54 may be supported. As those skilled in the art will certainly appreciate other coupling structures may be utilized in securing the first and second ends of the second strap member.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. An accessory support, comprising:
a first strap member, a second strap member and a third strap member securely connected together for use in supporting accessories;
the first strap member includes a first end and a second end wherein the first end is provided with a first fastening member and the second end is provided with a second fastening member, and the first and second fastening members are shaped and dimensioned for selective attachment to create a loop of the first strap member;
the second strap member includes a first end and a second end wherein the first end is provided with a fastening material;
the third member includes a first end and a second end wherein the first end is provided with a first fastening member and the second end is provided with a second fastening member, and the first and second fastening members are shaped and dimensioned for selective attachment to create a loop of the third strap member.

2. The accessory support according to claim 1, wherein the first fastening member and the second fastening member of the first strap member are respectively hook & loop fastening material adapted for selectively engagement therewith.

3. The accessory support according to claim 1, wherein the fastening material of the second strap member is hook or loop fastening material.

4. The accessory support according to claim 1, wherein the first fastening member and the second fastening member of the third strap member are respectively snap type fastening members adapted for selectively engagement therewith.

5. The accessory support according to claim 4, wherein the snap type fastening members are magnetic snaps.

6. The accessory support according to claim 1, wherein first and second strap members are integrally formed in a one-piece construction.
